(19) United States
(12) Patent Application Publication
(10) Pub. No.: US 2004/0141104 A1
(43) Pub. Date: Jul. 22, 2004

(54) Surface lighting device and liquid crystal display using the same

(76) Inventors: Tai-Cheng Yu, Tu-Chen (TW); Charles Leu, Fremont, CA (US); GaLane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/748,315

(22) Filed: Dec. 29, 2003

(30) Foreign Application Priority Data
Dec. 27, 2002 (TW) 91137597

(51) Int. Cl. G02F 1/1335

(52) U.S. Cl. 349/65

(57) ABSTRACT

A surface lighting device (100) includes a light guide plate (140), a plurality of point light sources (120), and a micro-lens array (130) for collimating light beams emitted from the point light sources into parallel rays. The light guide plate has a light incident surface (141). The point light sources are located opposite to the light incident surface. The micro-lens array is positioned between the point light source and the light incident surface, and the light guide plate and the point light source are placed at respective working distances from the micro-lens array. Divergent rays emitted from the point light sources are coupled into the light incident surface via the micro-lens array.

### BACKGROUND OF THE INVENTION

1. Field of the Invention

The present invention relates to a surface lighting device for use in a liquid crystal display (LCD) or the like, and particularly to a surface lighting device with micro-lenses for collimating light beams emitting from point light sources.

2. Prior Art

Most users expect displays in portable devices such as laptop and notebook computers, mobile phones and game devices to have large, clear and bright viewing screens. It is desired that such displays provide performance equal to that of desktop cathode-ray tube (CRT) monitors of personal computers. LCDs are one type of flat panel display (FPD) which can satisfy these expectations. However, because liquid crystals are not self-luminescent, LCDs need a surface lighting device which offers sufficient luminance (brightness) for a planar display surface. Typically, surface lighting devices have one of two types of light sources: one being linear sources such as cold cathode fluorescent lamps (CCFLs), and the other being point sources such as light emitting diodes (LEDs). Different types of light sources require different surface lighting device design structures.

As shown in FIG. 12, a conventional surface lighting device 10 which uses point light sources comprises a light guide plate 15 and three point sources 13 positioned at one side of the light guide plate 15. The light guide plate 15 couples with light beams emitted from the point sources 13 to create a surface lighting device for irradiating a liquid crystal panel (not shown). The point sources 13 are LEDs, each of which provides a Gaussian emission beam. That is, a measured distribution of optical intensity of the emission beam yields a Gaussian curve.

In operation, the Gaussian beams from the point sources 13 irradiate an end surface (not labeled) of the light guide plate 15. Some of the beams may transmit in the light guide plate 15, and some may be emitted out of the light guide plate 15 through an output surface (not labeled) that is perpendicular to the end surface. As seen in FIG. 12, lower intensity parts of the Gaussian beams illuminate areas D, E, F, G between and adjacent the point sources 13. Indeed, some areas at respective mid-points between adjacent point sources 13 receive almost no beams whatsoever. Darkened areas are formed near said mid-points. The surface lighting device cannot produce uniform brightness over an entire area of the liquid crystal display panel.

It is desirable to provide an improved surface lighting device for use in a liquid crystal display device which overcomes the above-described problems.

### SUMMARY OF THE INVENTION

An object of the present invention is to provide a surface lighting device with uniform luminance.

To achieve the above object, a surface lighting device in accordance with the present invention comprises a light guide plate, a plurality of point light sources, and a micro-lens array for collimating light beams emitted from the point light sources into parallel rays. The light guide plate has a light incident surface. The point light sources are located opposite to the light incident surface. The micro-lens array is positioned between the point light sources and the light incident surface, and the light guide plate and the point light sources are placed at respective working distances from the micro-lens array. The divergent rays emitted from the point light sources are coupled into the light incident surface via the micro-lens array.

Other objects, advantages, and novel features of the present invention will become more apparent from the following detailed description when taken in conjunction with the accompanying drawings, in which:

### BRIEF DESCRIPTION OF THE DRAWINGS

FIG. 1 is an isometric view of a first surface lighting device according to the present invention;

FIG. 2 is a bottom elevation of the first surface lighting device of FIG. 1;

FIG. 3 is a top elevation light path diagram of any one micro-lens of the first surface lighting device of FIG. 1;

FIGS. 4-8 are similar to FIG. 3, but show respective alternative embodiments of any one micro-lens of the first surface lighting device of FIG. 1;

FIG. 9 is an isometric view of a second surface lighting device according to the present invention;

FIG. 10 is an isometric view of a third surface lighting device according to the present invention;

FIG. 11 is an exploded side elevation of a liquid crystal display device employing the surface lighting device of FIG. 1; and

FIG. 12 is a schematic, isometric view of a conventional surface lighting device having a plurality of LEDs as light sources.

### DETAILED DESCRIPTION OF THE INVENTION

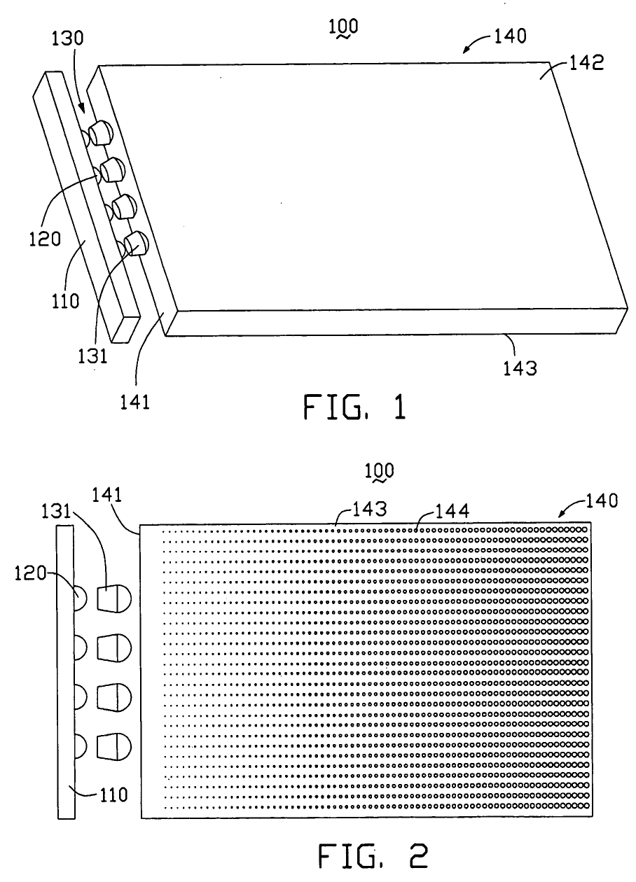

Referring to FIGS. 1 and 2, a first surface lighting device 100 in accordance with the present invention is used to illuminate a liquid crystal display panel. The surface lighting device 100 comprises a plurality of light sources 120, a micro-lens array 130, and a light guide plate 140.

The light sources 120 are fixed on a mounting portion 110 for stable emission of light beams. The light sources 120 can be light emitting diodes (LEDs), miniature bulbs, or the like.

The light guide plate 140 is a plane rectangular slab of transparent material such as acrylic resin, polycarbonate resin, polyvinyl chloride, or glass. The light guide plate 140 can alternatively be wedge-shaped (see FIG. 10), or have a triangular profile. The light guide plate 140 comprises a light incident surface 141, a light output surface 142 adjoining the light incident surface 141, and a bottom surface 143 opposite to the light output surface 142. The light incident surface 141 and/or the light output surface 142 may each have an anti-reflection coating (not shown) thereon, to reduce reflections therefrom. The bottom surface 143 comprises a dot pattern 144 formed thereon, for improving uniformity of light emitted from the light guide plate 140. The dot pattern 144 can be manufactured by a screen-printing process or by an injection molding process. A size of the dots in the dot-pattern 144 progressively increases in a direction away from the light incident surface 141. A shape of each dot can be hemispherical, cylindrical, conical, or parallelepiped with a square profile. Alternatively, a plurality of v-cut grooves (not shown) can be formed in the bottom surface 143 instead of having the dot pattern 144. The bottom surface 143 further includes a reflective film coating (not shown) thereon, which prevents leakage of light beams out through the bottom surface 143 by reflecting the light beams back into the light guide plate 140 and.

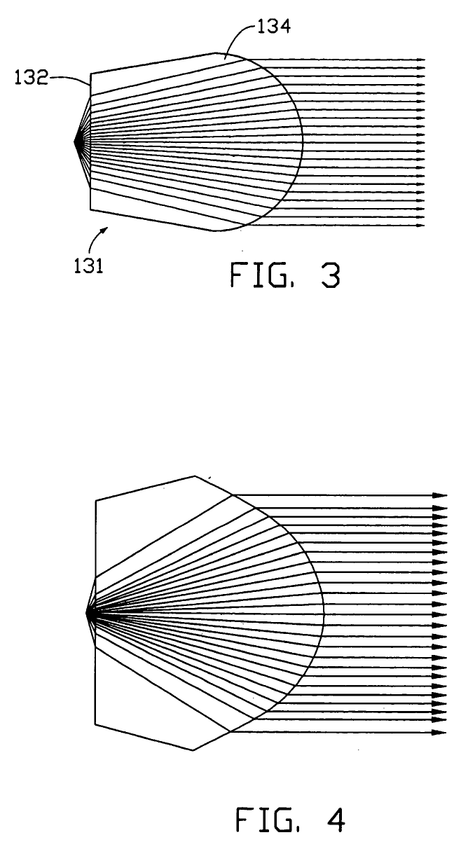

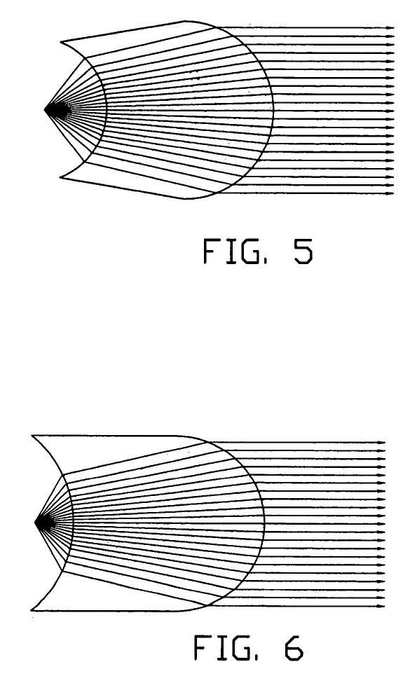

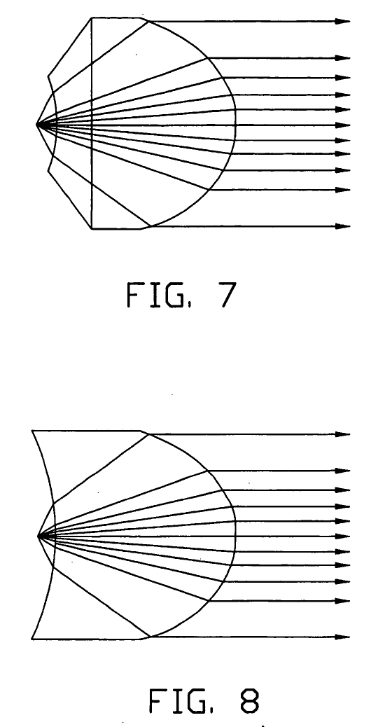

The micro-lens array 130 is located between the light sources 120 and the light incident surface 141, for coupling light beams emitted from the light sources 120 into the light incident surface 141. The micro-lens array 130 comprises a plurality of micro-lenses 131, corresponding in number to the number of light sources 120. Referring to FIG. 3, each micro-lens 131 preferably has a superconic cross-section, as disclosed in U.S. Pat. No. 5,745,519 issued to Ruda et al. In particular, the micro-lens 131 comprises a plane input first surface 132 facing the corresponding light source 120, and a convex emission second surface 134 opposite to the light incident surface 141. Light beams emitted from the light source 120 enter the micro-lens 131 through the first surface 132, and exit the micro-lens 131 through the second surface 134. The light beams passing through the micro-lens 131 are greatly affected by the shape of the first surface 132 and the second surface 134. In addition, characteristics of the light beams depend upon their directions of propagation from the light source 120. As illustrated, when the first surface 132 is flat and the second surface 134 is convex, the micro-lens 131 operates as a collimating lens. That is, light is partially focused at the first surface 132, and emerges from the second surface 134 as parallel rays. Other alternative cross-sectional shapes for the micro-lens 131 are known in the art. FIG. 4 shows an alternative embodiment of the micro-lens 131. FIGS. 5-8 show other alternative embodiments of the micro-lens 131. As shown, each such alternative micro-lens 131 comprises a concave light incident surface facing the point light source 120, and a convex surface opposite to the light incident surface 141. In addition, other cross-sectional shapes are known in the art, such as elliptical and hyperbolic shapes.

In operation, the light guide plate 140 and the light sources 120 are each placed at respective working distances away from the micro-lens array 130. The micro-lenses 131 collimate divergent light beams emitted from the light sources 120 into parallel rays, and couples the parallel rays into the light guide plate 140 through the light incident surface 141.

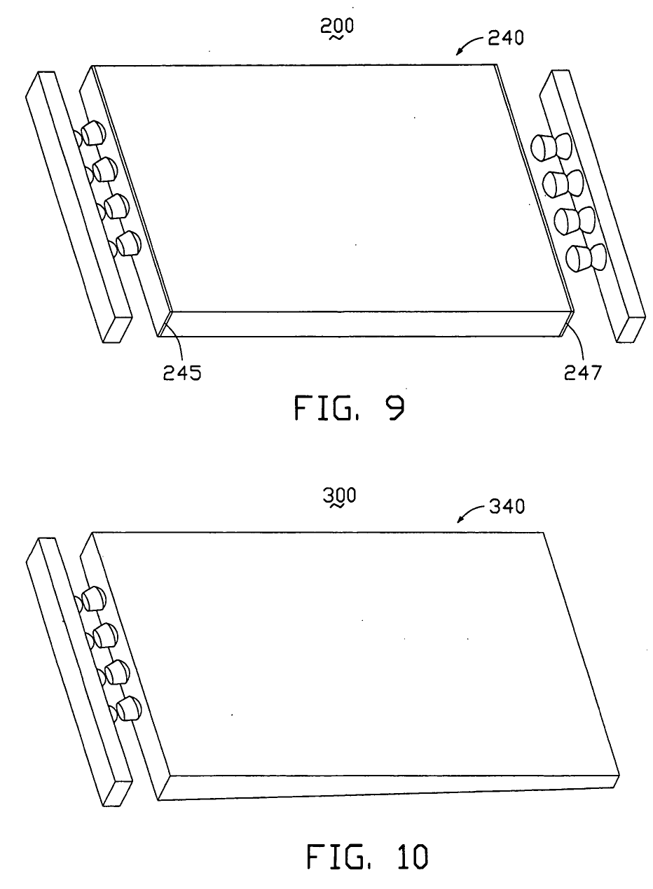

FIG. 9 shows a second surface lighting device 200 according to the present invention. The second surface lighting device 200 is similar to the first surface lighting device 100, except that the second surface lighting device 200 comprises two micro-lens arrays (not labeled) located at opposite sides of a light guide plate 240 respectively. The surface lighting device 200 further comprises two anti-reflective films (245, 247) coated on opposite light incident surfaces (not labeled) respectively, to reduce reflections therefrom. FIG. 10 shows a third surface lighting device 300 according to the present invention. The third surface lighting device 300 is similar to the first surface lighting device 100, except that it has a light guide plate 340 that is wedge-shaped.

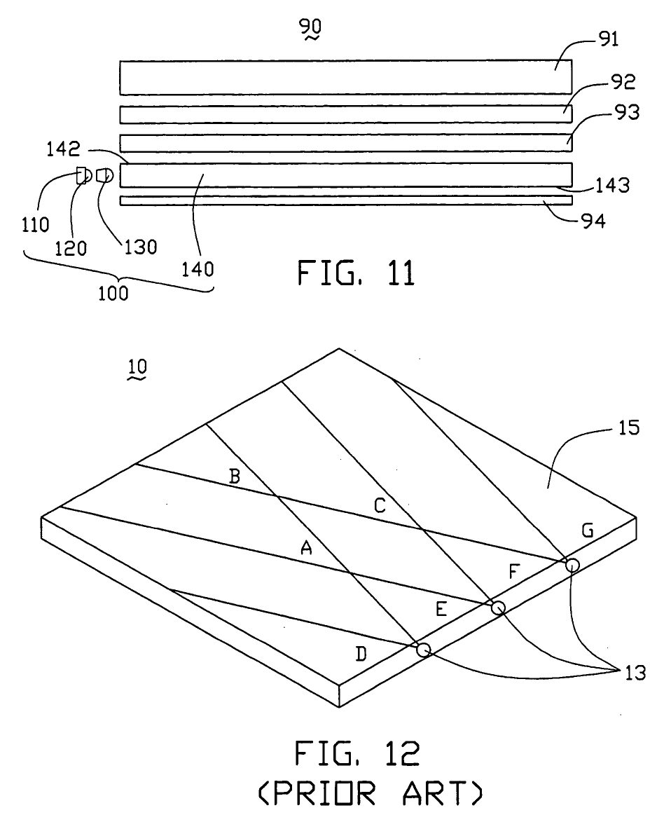

FIG. 11 shows an LCD device 90 employing the surface lighting device 100. The LCD device 90 comprises a reflection sheet 94, the surface lighting device 100, a diffusion sheet 93, a prism sheet 92 and a liquid crystal panel 91 which are stacked one on the other in that order. In operation, light beams emitted by the light sources 120 enter the light guide plate 140 of the surface lighting device 100, are transmitted out from the light output surface 142, and then pass through the diffusion sheet 93 and the prism sheet 92 to illuminate the liquid crystal panel 91. The reflection sheet 94 reflects light beams transmitting through the bottom surface 143 of the light guide plate 140 back into the light guide plate 140 for ultimate transmission out from the light output surface 142.

Unlike in the prior art, divergent light beams emitted from the light sources 120 are changed into parallel rays by passing through the micro-lenses 131. Light beams directed into the light guide plate 140, 240, 340 are more uniform, thus enabling the surface lighting device 100, 200, 300 to provide uniform illumination.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surface lighting device for a display device, comprising:
a light guide plate having a light incident surface;
a point light source opposite to the light incident surface; and
a micro-lens located between the point light source and the light incident surface, for collimating divergent rays emitted from the point light source into parallel rays;
wherein the light guide plate and the point light source are placed at respective working distances from the micro-lens, whereby the divergent rays emitted from the point light source are coupled into the light incident surface via the micro-lens.

2. The surface lighting device as described in claim 1, wherein the micro-lens has a superconic cross-section.

3. The surface lighting device as described in claim 1, wherein the micro-lens comprises a plane surface facing the point light source and a convex surface opposite to the light incident surface.

4. The surface lighting device as described in claim 1, wherein the micro-lens comprises a concave surface facing the point light source and a convex surface opposite to the light incident surface.

5. The surface lighting device as described in claim 1, wherein the point light source is a light emitting diode or a miniature bulb.

6. The surface lighting device as described in claim 1, wherein the light guide plate is parallepiped-shaped, wedge-shaped, or has a triangular profile.

7. The surface lighting device as described in claim 1, wherein the light guide plate further comprises a light output surface adjoining to the light incident surface, and a bottom surface opposite to the light incident surface.

8. The surface lighting device as described in claim 7, wherein the bottom surface has a dot pattern thereon, or has a plurality of v-cut grooves therein.

9. The surface lighting device as described in claim 7, wherein the light incident surface has an anti-reflective film thereon.

10. A liquid crystal display device comprising:
a liquid crystal panel; and
a surface lighting device arranged under the liquid crystal panel for illuminating the liquid crystal panel, the surface lighting device comprising:
point light sources for emitting light beams;
a light guide plate having a light input surface for receiving the light beams and a light output surface for emitting the light beams; and
micro-lenses for coupling the light beams from the point light sources into the light incident surface;
wherein the micro-lenses are positioned between the point light sources and the light incident surface, and the light beams emitted from the point light sources are coupled into the light incident surface via the micro-lenses.

11. The liquid crystal display device as claimed in claim 10, wherein the micro-lenses collimate the light beams from the point light sources such that the light beams coupled into the light incident surface are substantially parallel.

12. The liquid crystal display device as claimed in claim 10, wherein each of the micro-lenses has a superconic cross-section.

13. The liquid crystal display device as claimed in claim 10, wherein each of the micro-lenses comprises a plane surface facing the point light source and a convex surface opposite to the light incident surface.

14. The liquid crystal display device as claimed in claim 10, wherein each of the micro-lenses comprises a concave surface facing the point light source and a convex surface opposite to the light incident surface.

15. A surface lighting device for a display device, comprising:
a light guide plate having a light incident surface;
at least one light source opposite to the light incident surface; and
a lens located between the light source and the light incident surface, for collimating divergent rays emitted from the light source into non-divergent rays;
wherein the light guide plate and the point light source are placed at respective working distances from the lens, whereby the divergent rays emitted from the light source are coupled into the light incident surface via the lens.

16. The light device as described in claim 15, wherein said coupled non-divergent rays are essentially in a parallel manner.

17. The light device as described in claim 16, wherein said rays in the parallel manner are perpendicular to said light incident surface.
